(19) United States
(12) Patent Application Publication
(10) Pub. No.: US 2009/0032750 A1
(43) Pub. Date: Feb. 5, 2009

(54) Control valve for variable capacity compressors

(75) Inventors: Daisuke Morisawa, Tokyo (JP); Yoshiyuki Kume, Tokyo (JP)

Correspondence Address: Reed Smith LLP, Suite 1400, 3110 Fairview Park Drive, Falls Church, VA, 22042-0681, US

(73) Assignee: Fujikoki Corporation

(21) Appl. No.: 12/219,813

(22) Filed: Jul. 29, 2008

(30) Foreign Application Priority Data
Aug. 3, 2007 (JP) 2007-203556

(51) Int. Cl. F16K 31/06

(52) U.S. Cl. 251/129.01

(57) ABSTRACT

A control valve for a variable capacity compressor, which makes it possible to increase the full open flow rate so as to make it applicable to even a compressor of large capacity without inviting any substantial increase in size and weight, and to minimize the quantity of leakage of cooling medium from the valve chamber into the suction pressure cooling medium-introducing chamber to thereby make it possible to enhance the accuracy of control and to suppress the occurrence of operational failure including the clogging due to foreign substances, the locking of valve rod, etc. The valve rod is provided, at a lower portion thereof, with a lower valve body portion (16A) and an upper valve body portion (16B), and the valve chamber is provided with a lower valve seat (22a) and an upper valve seat (22b) in such a manner that the lower valve body portion (16A) and the upper valve body portion (16B) are concurrently enabled to detachably contact with their respective valve seats, and a lower cooling medium outlet chamber (26A) and an upper cooling medium outlet chamber (26B) are disposed on the downstream sides of the lower valve seat (22a) and of the upper valve seat (22b), respectively.

### BACKGROUND OF THE INVENTION

1. Field of the Invention

The present invention relates to a control valve for variable capacity compressors which is designed to be employed in air conditioners for vehicles, etc., and in particular to a control valve for variable capacity compressors which is designed such that a valve rod which is slidably and snugly inserted into a guide hole can be scarcely brought into malfunctioning.

2. Description of the Related Art

The control valve for variable capacity compressors which is designed to be employed in air conditioners for vehicles, etc. is generally constructed such that a cooling medium having a discharge pressure “Pd” is permitted to enter into the crank chamber of compressor from the discharge chamber of compressor so as to adjust the pressure “Pc” inside the crank chamber. In this case, the flow rate of cooling medium having a discharge pressure “Pd” to the crank chamber is restricted in such a manner that the quantity of supply (amount of throttling) of cooling medium to the crank chamber is controlled depending on the suction pressure “Ps” of compressor.

There is known as one example of such a control valve for variable capacity compressors as seen from JP Patent Laid-open Publication (Kokai) No. 2006-291867. Specifically, this known control valve comprises a valve main body which includes a valve rod comprising a shank portion and a valve body portion, a guide hole into which the shank portion is enabled to be slidably and snugly inserted, and a valve chamber provided with a valve seat which the valve body portion is enabled to detachably contact with; an electromagnetic actuator for driving the valve rod in a valve-opening or closing direction; and a pressure sensitive driving member for driving the valve rod in a valve-opening or closing direction in response to the suction pressure “Ps” of a compressor; wherein the valve main body is further provided with cooling medium inlet ports formed on the upstream side of the valve seat for introducing a cooling medium having a discharge pressure “Pd” from the compressor, and with a cooling medium outlet chamber which is disposed on the downstream side of the valve seat and communicated with a crank chamber of the compressor.

In the control valve for variable capacity compressors constructed in this manner, it has been studied to increase the effective aperture area of the valve seat (valve port) in order to increase a full open flow rate, i.e. the maximum flow rate of cooling medium to be supplied from the cooling medium outlet chamber to the crank chamber of the compressor, so as to make the control valve applicable to a compressor of large capacity.

One example of the control valve for variable capacity compressors wherein the effective aperture area of the valve seat is increased as described above will be briefly explained with reference to FIG. 3. The control valve 5 shown in FIG. 3 comprises a valve rod 15 formed integral with an operating rod 14, a valve main body 20, and electromagnetic actuator 30. The valve rod 15 includes an upper small diameter shank portion 15a which is formed contiguous to a lower shank portion 14b of the operating rod 14 via a plunger-engaging annular groove portion (small diameter portion) 15d, an intermediate large diameter shank portion 15b, a lower small diameter shank portion 15c having a smaller diameter than that of the intermediate large diameter shank portion 15b, and a valve body portion 16 having a larger diameter than that of the lower small diameter shank portion 15c. Further, a spring chamber acting also as a leak-out cooling medium chamber (hereinafter referred to as a spring chamber/leak-out cooling medium chamber) 53 is formed between the ceiling surface of guide hole 19b and the shoulder portion (step portion) of the intermediate large diameter shank portion 15b. Further, a valve-opening spring 47 made of a compression coil spring for urging the valve rod 15 downward (in the direction to open the valve) is disposed in the spring chamber/leak-out cooling medium chamber 53.

Further, the valve main body 20 is provided therein with guide holes 19a and 19b for enabling the upper small diameter shank portion 15a and the intermediate large diameter shank portion 15b of the valve rod 15 to be slidably and snugly inserted therein, respectively. The valve main body 20 is further provided therein with a valve chamber 21 having a valve port 22 which is provided with a valve seat 22a which the valve body portion 16 is enabled to detachably contact with from below. The outer circumferential wall portion (at a portion on the upstream side of the valve seat 22a) of valve chamber 21 of the valve main body 20 is provided with both a cooling medium inlet port 25 for introducing a cooling medium of discharge pressure “Pd” from the compressor and a cooling medium outlet chamber 26 which is disposed on the downstream side of the valve seat 22a and communicated with a crank chamber of the compressor. In this case, in order to increase the full open flow rate, the aperture (effective aperture area) of the valve seat 22a is made considerably larger than that of the conventional valve seat. Correspondingly, the outer diameter of the intermediate large diameter shank portion 15b to be slidably moved in the guide hole 19b is also made approximately as large as the enlarged aperture of valve seat 22a (thereby adjusting the downward valve-opening load to be imposed by the discharge pressure “Pd” applied to the valve rod 15 so as to make it almost equal to the upward valve-closing load).

Further, in the case of the control valve 5 constructed in this manner, since the pressure of cooling medium (discharge pressure “Pd”) to be introduced into the valve chamber 21 from the cooling medium inlet port 25 is higher than the pressure of cooling medium in the suction pressure cooling medium-introducing chamber 23 (suction pressure “Ps”), a portion of the cooling medium that has been introduced into the valve chamber 21 is permitted to leak into the suction pressure cooling medium-introducing chamber 23 through a gap formed between the slide-contacting surface of the intermediate large diameter shank portion 15b of valve rod 15 and that of the guide hole 19b. However, since the control of the compressor would be more adversely affected as the quantity of this Pd→Ps leak increases, a lead-out passageway 54 for communicating the spring chamber/leak-out cooling medium chamber 53 with the cooling medium outlet chamber 26 is provided in the intermediate large diameter shank portion 15b of valve rod 15, thereby limiting the Pd→Ps leak to as minimum as possible. This lead-out passageway 54 is constituted by a plurality of transverse holes 19b and a longitudinal hole 54b longitudinally passing through an axial portion of the intermediate large diameter shank portion 15b. In this case, a portion of the cooling medium having a discharge pressure “Pd” and introduced into the valve chamber 21 from the cooling medium inlet port 25 is permitted to enter into the spring chamber/leak-out cooling medium chamber 53 through a gap formed between the slide-contacting surface of the guide hole 19b and that of the intermediate large diameter shank portion 15b and then delivered, via the lead-out passageway 54, to the cooling medium outlet chamber 26.

The electromagnetic actuator 30 is equipped with a coil 32 having a connector 31 for energizing for excitation, with a cylindrical stator 33 disposed on the inner circumferential wall side of the coil 32, with an attractor 34 having U-shaped cross-section and being press-inserted into an inner circumferential lower end portion of the stator 33 and fixed, with a flange (35a)-attached pipe 35 which is joined, through an upper end portion thereof and by means of TIG welding, to an outer circumferential lower end portion (step portion) of the stator 33, with a plunger 37 being slidably disposed so as to enable itself to move up and down inside the pipe 35 and being placed below the attractor 34, and with a cylindrical housing 60 having an opening in its bottom and being disposed to cover the outer circumferential wall of the coil 32.

Additionally, a hexagon socket head adjusting screw 65 is threadably mounted on an upper portion of the stator 33. A pressure sensitive chamber 45 into which the suction pressure “Ps” of compressor is to be introduced is formed between the adjusting screw 65 and the attractor 34 inside the inner circumferential wall of stator 33. In this pressure sensitive chamber 45, there is disposed, as a pressure sensitive driving member, a bellows main body 40 consisting of a bellows 41, a downwardly projected upper stopper 42, a reversed U-shaped lower stopper 43 and a compression coil spring 44. Further, a compression coil spring 46 for urging the bellows main body 40 to contract (in the direction to compress it toward the adjusting screw 65) is interposed between the bellows main body 40 and the attractor 34. Further, a step-attached operating rod 14 comprising both an upper small diameter shank portion 14a piercing through the attractor 34 and a lower large diameter shank portion 14b is interposed between the reversed U-shaped lower stopper 43 of bellows main body 40 and a U-shaped portion 37b of plunger 37. To this operating rod 14, the aforementioned valve rod 15 is integrally connected.

In this example, the valve rod 15 is formed integral with the operating rod 14. Further, in the case of the control valve described in JP Patent Laid-open Publication (Kokai) No. 2006-291867, the valve rod 15 is urged upward by means of a valve-closing spring disposed in the cooling medium outlet chamber 26, thereby pressing the valve rod 15 against the plunger 37. Whereas, in this example, such a valve-closing spring is not disposed, and an annular groove portion (a small diameter portion) 15b is formed at a boundary portion between the shank portion 15b of valve rod 15 and the lower large diameter shank portion 14b (having the same diameter as that of the shank portion 15b) of the operating rod 14, and an engaging portion 38 which is provided at a bottom portion of the concave hole 37g of the plunger 37 is fitted in the annular groove portion 15d, thereby enabling the valve rod 15 and the plunger 37 to move up and down together in a unified manner.

The reason for constructing the control valve in this manner can be explained as follows. Namely, when the control valve is constructed such that the valve rod 15 is enabled to move in the valve-closing direction by means of only the urging force of the valve-closing spring 48, foreign material may be caught in (gap) between the slide-contacting interface of the intermediate large diameter shank portion 15b of valve rod 15 and that of the guiding hole 19b, or the sliding resistance of valve rod 15 may be caused to increase due to the oil-seizing, etc., thereby giving rise to the malfunctioning of the valve rod 15 such as locking of valve rod 15. For example, there may be generated a situation wherein the valve rod 15 cannot be moved in the valve-closing direction and is left behind even if the plunger is pulled close to the attractor. If such a situation is caused to generate, it is no longer possible to suitably control the degree of valve opening. Whereas, when the valve rod 15 is substantially directly connected with the plunger as described above, it is possible to obviate the aforementioned problems and, at the same time, it is possible to dispense with the employment of the valve-closing spring.

On the other hand, a convex stopper 28 for regulating the lowermost descending position of the plunger 37 is projected upward from an upper central portion of the valve main body 20. A suction pressure cooling medium-introducing chamber 23 for enabling a cooling medium of suction pressure of the compressor to be introduced therein is formed between the plunger 37 and an upper outer circumferential wall of the valve main body 20 (an outer circumferential wall of the convex stopper 28). A plurality of suction pressure cooling medium-introducing ports 27 are formed in the outer circumferential wall of the suction pressure-introducing chamber 23. A cooling medium of suction pressure “Ps” that has been introduced into the suction pressure cooling medium-introducing chamber 23 from the cooling medium-introducing ports 27 is designed to be introduced into the pressure sensitive chamber 45 via longitudinal grooves 37a, 37a, . . . , formed on the outer circumferential wall of plunger 37, via a cutout opening 37f, via a concave hole 37g formed at a central axis of plunger 37 and via a through-hole 39 formed in the attractor 34.

A lower flange portion 35a of the pipe 35 is mounted, through an O-ring 57, on an upper end of the valve main body 20. A flange (56a)-attached short cylindrical pipe holder 56 is interposed between the flange portion 35a and the coil 32. These flange portions 35a and 56a are both fixed to each other by means of the upper end outer circumferential caulking portion 29 of the valve main body 20. An open bottom portion 61 of the housing 60 is press-inserted in and fixed to an upper end portion of the pipe holder 56. An upper end portion 62 of the housing 60 is caulked and fixed to the flange portion 31c of the connector 31. An O-ring 66 is interposed between the housing 60 and the connector 31 and the coil 32. By the way, at a lower central portion of the connector 31, there is formed a recessed portion 31a in which a projected portion 31b to be engaged with the hexagonal hole of the adjusting screw 65 is formed. An upper portion of the stator 33 as well as an upper portion of the adjusting screw 65 is inserted into this recessed portion 31a.

In the control valve 5 constructed as described above, as seen from FIG. 4(A) wherein a valve-opening state is shown and from FIG. 4(B) wherein a valve-closing state is shown, when the solenoid portion consisting of the coil 32, the stator 33 and the attractor 34 is energized for excitation in a valve-opening state, the plunger 37 is drawn toward the attractor 34, thereby the valve rod 15 being forced to move upward (in the valve-closing direction). On the other hand, the cooling medium of suction pressure “Ps” that has been introduced into the suction pressure cooling medium-introducing ports 27 from the compressor is introduced from the suction pressure cooling medium-introducing chamber 23 into the pressure sensitive chamber 45 via longitudinal grooves 37a, 37a, . . . formed on the outer circumferential wall of plunger 37, via a through-hole 39 formed in the attractor 34, and via the like. As a result, the bellows main body 40 (the interior thereof is kept in vacuum) is caused to displace, i.e. contract or expand depending on the pressure (the suction pressure “Ps”) inside the pressure sensitive chamber 45 (when the suction pressure “Ps” is high, the bellows main body 40 is contracted, and when the suction pressure “Ps” is low, the bellows main body 40 is expanded). Then, this displacement is transmitted to the operating rod 14 and the valve rod 15, thereby making it possible to adjust the degree of valve opening (the lifting height of the valve body portion 16 from the valve seat portion 22a).

Namely, the degree of valve opening will be determined depending on the attracting force of the plunger 37 to be effected by the solenoid portion consisting of the coil 32, the stator 33 and the attractor 34, on the urging force of the bellows main body 40, on the urging force of the valve-opening spring 47, and on the load in the valve-opening direction and the load in the valve-closing direction to be imposed by the discharge pressure “Pd” on the valve rod 15. Further, depending on this degree of valve opening, the amount of throttling of cooling medium of discharge pressure “Pd” that has been introduced from the discharge pressure cooling medium inlet port 25 into the valve chamber 21, i.e. the quantity of cooling medium to be introduced into the crank chamber (amount of throttling) can be adjusted. In other words, depending on the degree of valve opening, the pressure “Pc” of cooling medium outlet chamber 26 side (hereinafter referred to as an outlet pressure Pc), i.e. the pressure inside the crank chamber, can be controlled. As a result, the inclination angle of the wobble plate of compressor as well as the stroke of piston can be adjusted, thus increasing or decreasing the quantity of cooling medium to be discharged.

As described above, the conventional control valve 5 for variable capacity compressors is accompanied with the following problems to overcome.

As described above, in the case of the above-described control valve 5, in order to increase the full open flow rate, the aperture (effective aperture area) of the valve seat 22a is made considerably larger than that of the conventional valve seat. Accordingly, the outer diameter of the intermediate large diameter shank portion 15b of valve 15 to be slidably moved in the guide hole 19b is also required to be made approximately as large as the enlarged aperture of valve seat 22a (thereby adjusting the downward valve-opening load to be imposed by the discharge pressure “Pd” applied to the valve rod 15 so as to make it almost equal to the upward valve-closing load). As described above, since the guide hole 19b and the intermediate large diameter shank portion 15b are both required to be increased in diameter, the above-described structure leads to the increase in size and weight of the control valve and, at the same time, since the contacting area between the guide hole 19b and the intermediate large diameter shank portion 15b is also caused to increase, the sliding frictional resistance at this contacting area is caused to increase, so that the electromagnetic actuator 30 is required to be selected from those having a larger output, resulting in increase of power consumption.

Additionally, since a total cross-sectional area of the gap to be formed between the slide-contacting surface of the intermediate large diameter shank portion 15b of valve rod 15 and that of the guide hole 19b is caused to increase, the quantity of leakage, toward the suction pressure cooling medium-introducing chamber 23, of the cooling medium (discharge pressure “Pd”) that has been introduced into the valve chamber 21 from the cooling medium inlet port 25 (i.e. the quantity of cooling medium passing through the gap formed between the slide-contacting surface of the intermediate large diameter shank portion 15b of valve rod 15 and that of the guide hole 19b) would be increased, resulting in the deterioration of accuracy of control. Further, since the total cross-sectional area of the gap is caused to increase, other problems may be caused to arise such as operational failure including the clogging due to foreign substances, the locking of valve rod, etc.

### SUMMARY OF THE INVENTION

The present invention has been made in view of the circumstances mentioned above and, therefore, an object of the present invention is to provide a control valve for a variable capacity compressor, which makes it possible to increase the full open flow rate so as to make it applicable to even a compressor of large capacity without inviting any substantial increase in size and weight, and to reduce the quantity of leakage of cooling medium from the valve chamber into the suction pressure cooling medium-introducing chamber to thereby make it possible to enhance the accuracy of control and to suppress the occurrence of operational failure including the clogging due to foreign substances, the locking of valve rod, etc.

With a view to achieving the aforementioned objects, there is provided, according to the present invention, a control valve for a variable capacity compressor, which fundamentally comprises a valve main body which includes a valve rod comprising a shank portion and a valve body portion disposed below the shank portion, a guide hole into which the shank portion is enabled to slidably and snugly inserted, and a valve chamber provided with a valve seat which the valve body portion is enabled to detachably contact with; an electromagnetic actuator for driving the valve rod in a valve-opening or closing direction; and a pressure sensitive driving member for driving the valve rod in a valve-opening or closing direction in response to the suction pressure “Ps” of a compressor; wherein the valve main body is further provided with a cooling medium inlet port formed on the upstream side of the valve seat for introducing a cooling medium having a discharge pressure “Pd” from the compressor, and with a cooling medium outlet chamber which is disposed on the downstream side of the valve seat and communicated with a crank chamber of the compressor.

This control valve is characterized in that the valve seats and the valve body portions each are provided one by one at a couple of locations, and the couple of valve seats are enabled to open or close concurrently by their respective valve body portions.

In a preferable embodiment, the valve body portions are disposed to open or close their respective valve seats from the undersides of their respective valve seats, and the cooling medium outlet chambers are disposed on the downstream sides of their respective valve seats.

In a more specific preferable embodiment, the valve body portions each are provided at a lower portion of the shank portion as a lower valve body portion and as an upper valve body portion, and the valve seats each are provided in the valve chamber as a lower valve seat and as an upper valve seat to thereby enable the lower valve body portion and the upper valve body portion to concurrently detachably contact with the lower valve seat and the upper valve seat, respectively, and the cooling medium outlet chambers each are provided on the downstream side of the lower valve seat and on the upstream side of the upper valve seat as a lower cooling medium outlet chamber and as an upper cooling medium outlet chamber, respectively.

In a further preferable embodiment, some of the cooling medium having a discharge pressure (Pd) and introduced into the cooling medium inlet port is throttled by both the lower valve seat and the lower valve body portion before it is led out to the lower cooling medium outlet chamber, while the rest of it is throttled by both the upper valve seat and the upper valve body portion before it is led out to the upper cooling medium outlet chamber, the cooling medium led out to the upper cooling medium outlet chamber being subsequently led out, via a lead-out passageway installed in the valve rod, to the lower cooling medium outlet chamber.

In a further preferable embodiment, some of the cooling medium having a discharge pressure (Pd) and introduced into the cooling medium inlet port is throttled by both the lower valve seat and the lower valve body portion before it is led out to the lower cooling medium outlet chamber, while the rest of it is throttled by both the upper valve seat and the upper valve body portion before it is led out to the upper cooling medium outlet chamber, the cooling medium led out to the upper cooling medium outlet chamber being subsequently led out, via a lead-out passageway installed in the valve main body and/or a lead-out passageway installed outside the valve main body, to the lower cooling medium outlet chamber.

In a further preferable embodiment, both of the valve seats are configured to have almost the same effective aperture area.

In the control valve for a variable capacity compressor according to the present invention, since the control valve is provided with, for example, a couple of valve seats and also with a couple of valve body portions for concurrently opening or closing their respective valve seats, it is possible to increase the full open flow rate without enlarging the aperture of valve seat, thereby making the control valve applicable to even a compressor of large capacity without inviting any substantial increase in size and weight.

Furthermore, differently from the conventional control valves, since the outer diameter of the shank portion of valve rod to be slidably moved in the guide hole is not required to be almost the same as that of the aperture of valve seat, it is possible to considerably decrease, as compared with the conventional valve rod, the outer diameter of the sliding portion of valve rod that slidably contacts with the guide hole, even when the full open flow rate were increased. Therefore, it is possible to miniaturize the control valve and to save the weight of control valve and, at the same time, since the contacting area between the guide hole and the valve rod 15 can be decreased, the sliding frictional resistances of these contacting portions can be minimized.

Additionally, since a total cross-sectional area of the gap to be formed between the slide-contacting surface of the shank portion of valve rod and that of the guide hole can be decreased, it is possible to suppress the occurrence of operational failure such as the clogging due to foreign substances, the locking of valve rod, etc.

In the case of the conventional control valve of this kind, the cooling medium having a discharge pressure “Pd” that has been introduced into the valve chamber from the cooling medium inlet port is permitted to leak toward the suction pressure cooling medium-introducing chamber after passing through a gap formed between the slide-contacting surface of the shank portion of valve rod and that of the guide hole. Whereas, in the case of the control valve of the present invention, the cooling medium that can be leaked toward the suction pressure cooling medium-introducing chamber is restricted to one which is throttled by both the upper valve seat and the upper valve body portion so as to have a lower outlet pressure Pc as compared with the discharge pressure “Pd”. Therefore, the quantity of leakage can be decreased, resulting in the enhancement of control accuracy of the control valve and in the suppression of occurrence of operational failure such as the clogging due to foreign substances, the locking of valve rod, etc.

### BRIEF DESCRIPTION OF THE DRAWINGS

FIG. 1 is a longitudinal sectional view illustrating one embodiment of the control valve for a variable capacity compressor according to the present invention;

FIG. 2(A) is an enlarged longitudinal sectional view illustrating a main portion of the control valve shown in FIG. 1 wherein the control valve is opened;

FIG. 2(B) is an enlarged longitudinal sectional view illustrating a main portion of the control valve shown in FIG. 1 wherein the control valve is closed;

FIG. 3 is a longitudinal sectional view illustrating one example of the conventional control valve for a variable capacity compressor;

FIG. 4(A) is an enlarged longitudinal sectional view illustrating a main portion of the control valve shown in FIG. 3 wherein the control valve is opened; and

FIG. 4(B) is an enlarged longitudinal sectional view illustrating a main portion of the control valve shown in FIG. 3 wherein the control valve is closed.

### DETAILED DESCRIPTION OF THE INVENTION

Next, a specific embodiment of the control valve for a variable capacity compressor according to the present invention will be explained in detail with reference to the drawings.

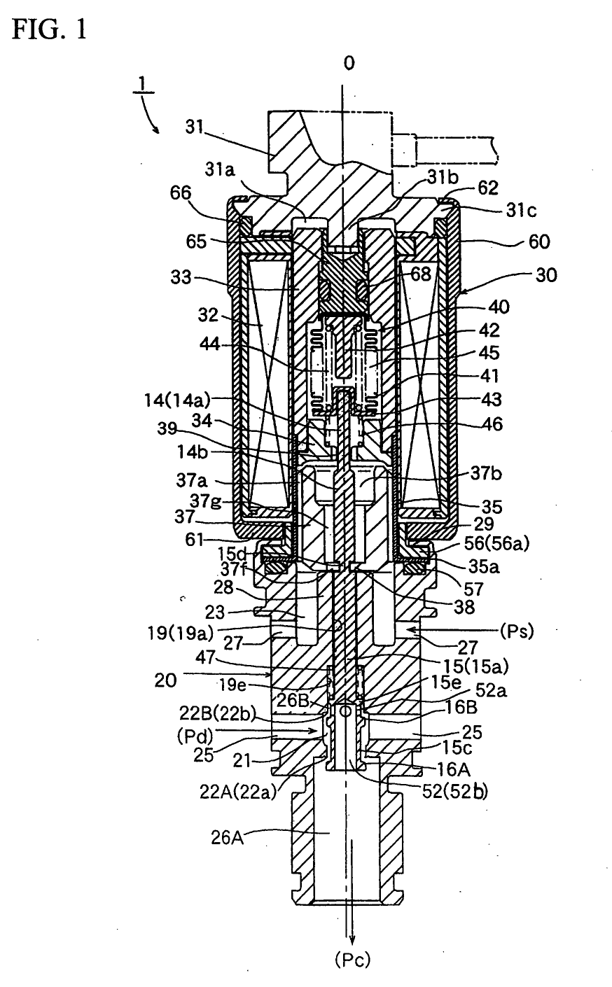

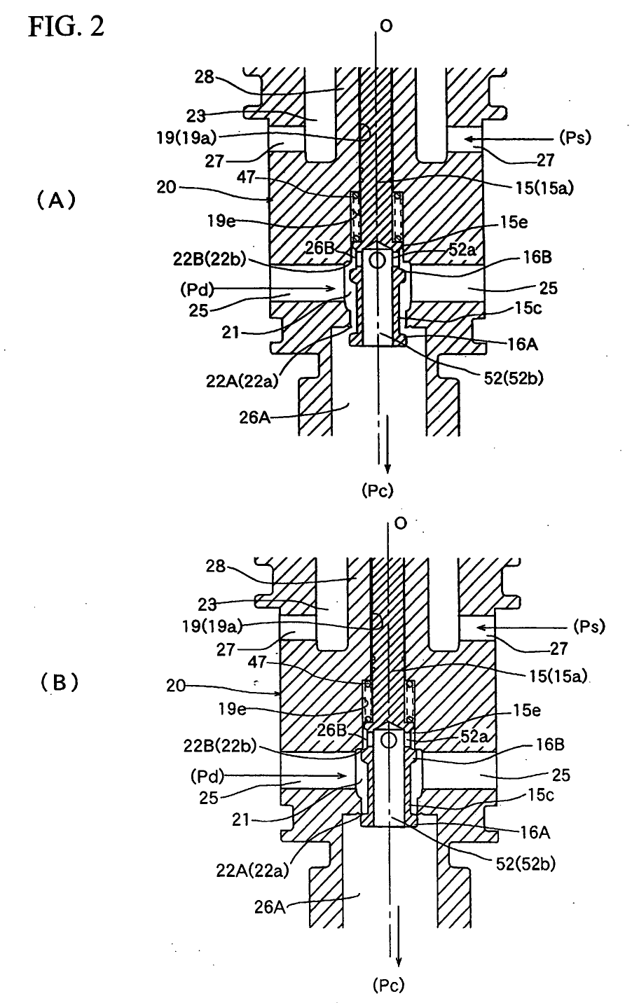

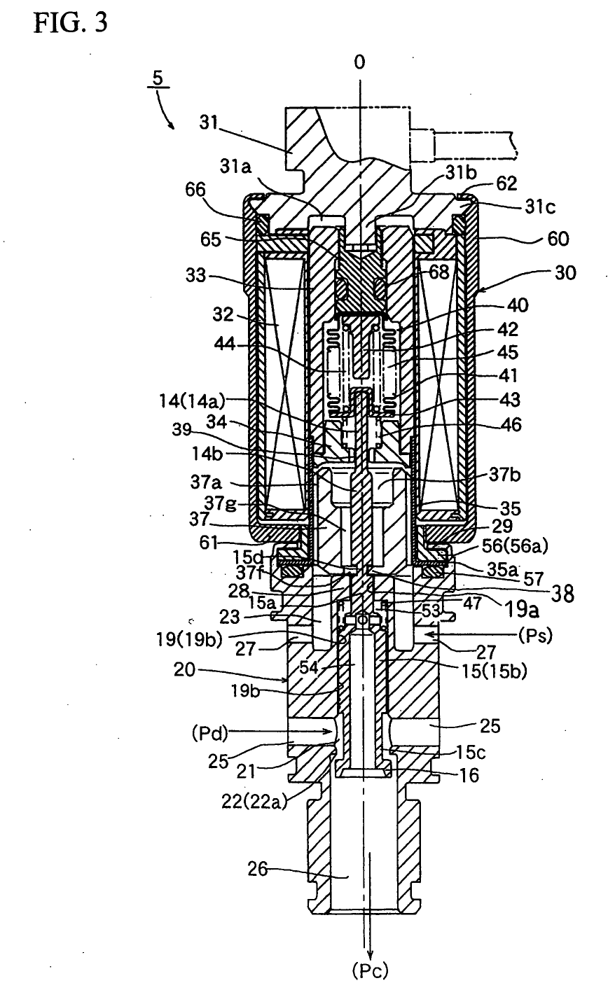

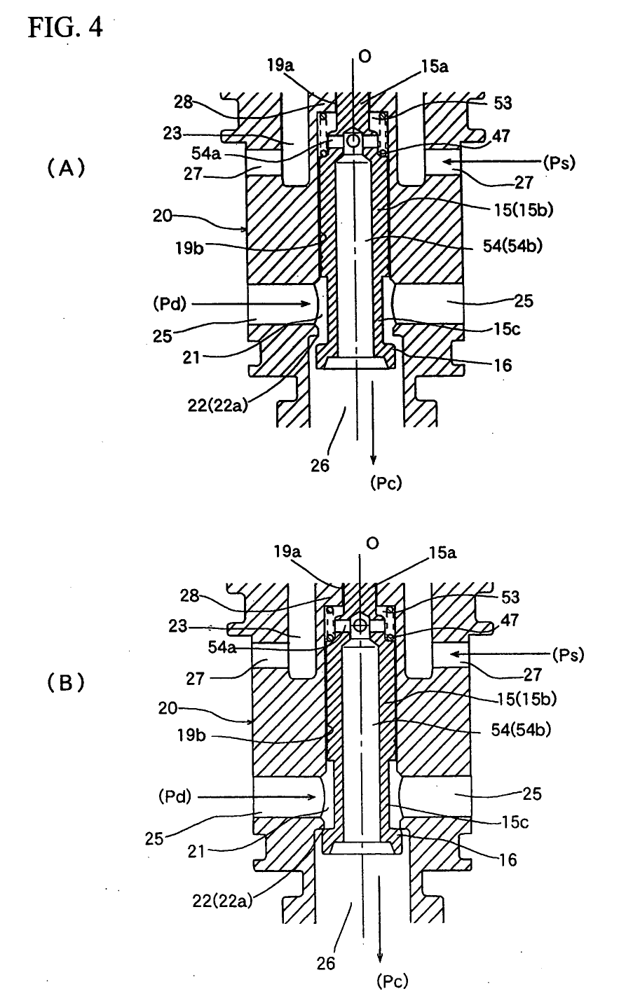

FIG. 1 is a longitudinal sectional view illustrating one embodiment of the control valve for a variable capacity compressor according to the present invention; FIG. 2(A) is an enlarged longitudinal sectional view illustrating a main portion of the control valve shown in FIG. 1 wherein the control valve is opened; and FIG. 2(B) is an enlarged longitudinal sectional view illustrating a main portion of the control valve shown in FIG. 1 wherein the control valve is closed. In the control valve 1 for a variable capacity compressor shown in FIGS. 1, 2(A) and 2(B), the parts or components which correspond to those of the conventional control valve 5 for a variable capacity compressor which is shown in FIGS. 3, 4(A) and 4(B) will be identified by the same reference numbers to thereby omit the repeated explanations thereof, and the features which differ from those of the conventional control valve 5 will be mainly explained as follows.

In the case of the control valve 1 according to the embodiment shown in these FIGS., a valve chamber 21 is provided with a couple of valve seats. Further, a couple of valve body portions are formed at a lower portion of the valve rod 15 and spaced apart from each other along the lower portion of the valve rod 15. By means of the couple of valve body portions, the couple of valve seats are concurrently opened or closed.

More specifically, at a lower edge portion of the valve chamber 21, there is provided a lower valve seat 22a (a lower valve port 22A) having a smaller aperture than that of the valve sheet of the conventional valve shown in FIG. 3, and at an upper edge portion (a lower edge portion of the guide hole 19) of the valve chamber 21, there is provided an upper valve seat 22b (an upper valve port 22B) having the same aperture (effective aperture area) as that of the lower valve seat 22a. Further, on the downstream side of the lower valve seat 22a, there is provided a lower cooling medium outlet chamber 26A which is similar to the conventional cooling medium outlet chamber 26, and on the downstream side (upper side) of the upper valve seat 22b, there is provided an upper cooling medium outlet chamber 26B.

The valve rod 15 includes an upper shank portion 15a which is formed contiguous, via a plunger-engaging annular groove portion (small diameter portion) 15d, to a lower shank portion 14b of the operating rod 14, a spring-receiving annular flange 15e formed at a lower edge portion of the upper shank portion 15a, and a lower small diameter shank portion 15c having a smaller diameter than that of the aperture of upper valve seat 22b and that of the outer diameter of the annular flange 15e and being disposed below the annular flange 15e. At a lower edge portion of the lower shank portion 15c, there is disposed a lower valve body portion 16A which is enabled to detachably contact with the lower valve seat 22a from below and at an upper end portion of the lower shank portion 15c, there is disposed an upper valve body portion 16B which is enabled to detachably contact with the upper valve seat 22b from below.

The guide hole 19 is constituted by an upper guide hole 19a in which the upper shank portion 15a is slidably inserted, and by a large diameter hole 19e in which the annular flange 15e is loosely inserted. A valve-opening spring 47 is interposed in a shrunken state between the ceiling of the large diameter hole 19e and the annular flange 15e. A space portion of the large diameter hole 19e, which is located below the annular flange 15e, is employed as the upper cooling medium outlet chamber 26B.

Inside the lower shank portion 15c of the valve rod 15, there is provided a lead-out passageway 52 for guiding the cooling medium that has been led out to the upper cooling medium outlet chamber 26B after being throttled by both the upper valve seat 22b and the upper valve body portion 16B detachably contacting with the upper valve seat 22b, toward the lower cooling medium outlet chamber 26A. This lead-out passageway 52 is constituted by a plurality of transverse holes 52a which are formed between the annular flange 15e and the upper valve body portion 16B, and by a longitudinal hole 52b longitudinally passing through an axial portion of the lower shank portion 15c.

Incidentally, the bore diameter of a portion of the guide hole 19 which is slidably contacted with the upper shank portion 15a (i.e. the diameter of the upper guide hole 19a) is made smaller than the aperture of the upper and lower valve seats 22a and 22b by a magnitude of not less than 20%.

In this embodiment, the outer diameters of the upper and lower valve body portions 16A and 16B are required to be made larger than the apertures of the upper and lower valve seats 22a and 22b. If so, it would be impossible to introduce the upper valve body portion 16B into the valve chamber 21 through the lower valve seat 22a. Therefore, the aperture of the lower valve port 22A is required to be set larger than the outer diameter of the upper valve body portion 16B before the assembling of the valve. After finishing the assembling of the valve, i.e. after the upper valve body portion 16B of valve rod 15 has been introduced into the valve chamber 21 through the lower valve port 22A, the inner circumferential portion of the undersurface of lower valve port 22A is beaten by means of a punch, etc. to reduce the diameter of the lower edge portion of lower valve port 22A (i.e. the diameter of the lower valve seat 22a).

In the control valve 1 for variable capacity compressors constructed as described above, as seen from FIG. 2(A) wherein a valve-opening state is shown and from FIG. 2(B) wherein a valve-closing state is shown, when the solenoid portion consisting of the coil 32, the stator 33 and the attractor 34 is energized for excitation in a valve-opening state, the plunger 37 is drawn toward the attractor 34, thereby the valve rod 15 being forced to move upward (in the valve-closing direction). As a result, the lower valve body portion 16A and the upper valve body portion 16B are moved close to the lower valve seat 22a and the upper valve seat 22b, respectively, thereby making it possible to adjust the degree of valve opening (amount of throttling).

More specifically, some of the cooling medium having a discharge pressure “Pd” from the compressor that has been introduced into the valve chamber 21 from the cooling medium inlet port 25 is enabled to lead out to the lower cooling medium outlet chamber 26A after being throttled by both the lower valve seat 22a and the lower valve body portion 16A, while the rest of it is enabled to lead out to the lower cooling medium outlet chamber 26A through the lead-out passageway 52 provided at the lower shank portion 15c of valve rod 15 after it has been led out to the upper cooling medium outlet chamber 26B after being throttled by both the upper valve seat 22b and the upper valve body portion 16B.

In the control valve 1 for a variable capacity compressor according to this embodiment, since the control valve is provided with a couple of valve seats 22a and 22b and also with a couple of valve body portions 16A and 16B for concurrently opening or closing these valve seats 22a and 22b, it is possible to increase the full open flow rate without enlarging the aperture of valve seat, thereby making the control valve applicable to even a compressor of large capacity without inviting any substantial increase in size and weight.

Furthermore, since the outer diameter of the shank portion of valve rod 15 to be slidably moved in the guide hole is not required to be almost the same as that of the aperture of valve seat as required in the case of conventional control valve shown in FIG. 3, it is possible to considerably decrease, as compared with the conventional valve rod shown in FIG. 3, the outer diameter of the sliding portion (upper shank portion 15a) of valve rod 15 that slidably contacts with the guide hole 19 (upper guide hole 19a), even when the full open flow rate were increased. Therefore, it is possible to miniaturize the control valve and to save the weight of control valve and, at the same time, since the contacting area between the guide hole 19 (upper guide hole 19a) and the valve rod 15 (upper shank portion 15a) can be reduced, the sliding frictional resistances of these contacting portions can be minimized.

Additionally, since a total cross-sectional area of the gap to be formed between the slide-contacting surface of the upper shank portion 15a of valve rod 15 and that of the guide hole 19 can be decreased, it is possible to suppress the occurrence of operational failure such as the clogging due to foreign substances, the locking of valve rod, etc.

In the case of the conventional control valve shown in FIG. 3, the cooling medium having a discharge pressure “Pd” that has been introduced into the valve chamber 21 from the cooling medium inlet port 25 is permitted to leak toward the suction pressure cooling medium-introducing chamber 23 after passing through a gap formed between the slide-contacting surface of the intermediate large diameter shank portion 15b of valve rod 15 and that of the guide hole 19b. Whereas, in the case of the control valve of the present embodiment, the cooling medium that can be leaked toward the suction pressure cooling medium-introducing chamber 23 is restricted to one which is throttled by both the upper valve seat 22b and the upper valve body portion 16B so as to have a lower outlet pressure Pc as compared with the discharge pressure “Pd”. Therefore, the quantity of leakage can be decreased, resulting in the enhancement of control accuracy of the control valve and in the suppression of occurrence of operational failure such as the clogging due to foreign substances, the locking of valve rod, etc.

In the above-described embodiment, the cooling medium that has been led out to the upper cooling medium outlet chamber 26B after being throttled by both the upper valve seat 22b and the upper valve body portion 16B is enabled to lead out to the lower cooling medium outlet chamber 26A through the lead-out passageway 52 provided at the lower shank portion 15c of valve rod 15. Alternatively, it is also possible, in place of the above-described structure, to provide a lead-out passageway in the main valve body 20 or outside the main valve body 20 wherein the cooling medium that has been led out to the upper cooling medium outlet chamber 26B after being throttled by both the upper valve seat 22b and the upper valve body portion 16B is enabled to lead out to the lower cooling medium outlet chamber 26A through this lead-out passageway provided in the main valve body 20 or outside the main valve body 20.

1. A control valve for a variable capacity compressor, which comprises:
a valve main body which includes a valve rod comprising a shank portion and a valve body portion disposed below the shank portion, a guide hole into which the shank portion is enabled to slidably and snugly inserted, and a valve chamber provided with a valve seat which the valve body portion is enabled to detachably contact with;
an electromagnetic actuator for driving the valve rod in a valve-opening or closing direction; and
a pressure sensitive driving member for driving the valve rod in a valve-opening or closing direction in response to the suction pressure “Ps” of a compressor;
wherein the valve main body is further provided with a cooling medium inlet port formed on an upstream side of the valve seat for introducing a cooling medium having a discharge pressure “Pd” from the compressor, and with a cooling medium outlet chamber which is disposed on a downstream side of the valve seat and communicated with a crank chamber of the compressor;
the control valve being characterized in that the valve seats and the valve body portions each are provided one by one at a couple of locations and the couple of valve seats are enabled to open or close concurrently by their respective valve body portions.

2. The control valve according to claim 1, wherein the valve body portions are disposed to open or close their respective valve seats from the undersides of their respective valve seats, and the cooling medium outlet chambers are disposed on the downstream sides of their respective valve seats.

3. The control valve according to claim 1, wherein the valve body portions each are provided at a lower portion of the shank portion as a lower valve body portion and as an upper valve body portion, and the valve seats each are provided in the valve chamber as a lower valve seat and as an upper valve seat to thereby enable the lower valve body portion and the upper valve body portion to concurrently detachably contact with the lower valve seat and the upper valve seat, respectively, and the cooling medium outlet chambers each are provided on the downstream side of the lower valve seat and on the downstream side of the upper valve seat as a lower cooling medium outlet chamber and as an upper cooling medium outlet chamber, respectively.

4. The control valve according to claim 3, wherein some of the cooling medium having a discharge pressure (Pd) and introduced into the cooling medium inlet port is throttled by both the lower valve seat and the lower valve body portion before it is led out to the lower cooling medium outlet chamber, while the rest of it is throttled by both the upper valve seat and the upper valve body portion before it is led out to the upper cooling medium outlet chamber, the cooling medium led out to the upper cooling medium outlet chamber being subsequently led out, via a lead-out passageway installed in the valve rod, to the lower cooling medium outlet chamber.

5. The control valve according to claim 3, wherein some of the cooling medium having a discharge pressure (Pd) and introduced into the cooling medium inlet port is throttled by both the lower valve seat and the lower valve body portion before it is led out to the lower cooling medium outlet chamber, while the rest of it is throttled by both the upper valve seat and the upper valve body portion before it is led out to the upper cooling medium outlet chamber, the cooling medium led out to the upper cooling medium outlet chamber being subsequently led out, via a lead-out passageway installed in the valve main body and/or a lead-out passageway installed outside the valve main body, to the lower cooling medium outlet chamber.

6. The control valve according to any one of claims 1, wherein both of the valve seats are configured to have almost the same effective aperture area.
